(19) United States
(12) Patent Application Publication
(10) Pub. No.: US 2015/0154719 A1
(43) Pub. Date: Jun. 4, 2015

(54) Valuation of Civil Legal Cases and Disputes

(71) Applicant: Brendon Ishikawa, Davis, CA (US)

(72) Inventor: Brendon Ishikawa, Davis, CA (US)

(21) Appl. No.: 14/093,375

(22) Filed: Nov. 29, 2013

(51) Int. Cl. G06Q 50/18; G06Q 10/00

(52) U.S. Cl. CPC G06Q 50/182; G06Q 10/00

(57) ABSTRACT

A system for computing present value of civil legal cases and disputes using decision tree analysis that accounts for multiple possible outcomes with differing chances of occurrence and/or economic result. The system also computes odds of success, remaining length of litigation, hidden assumptions conveyed in settlement offers, and trains users in the valuation process.

### BACKGROUND

1. Field of Invention

The present disclosure relates to valuating civil legal cases and disputes, and more particularly, to computer-implemented systems and methods for valuating civil legal cases and disputes.

2. Description of Related Art

This section introduces various aspects of the art, which may be associated with aspects of the disclosed processes and methodologies. This discussion is intended provide a framework for understanding particular aspects of the disclosure. Accordingly this section should be construed in this light and not necessarily as any admission of prior art.

The system of civil legal actions is founded on the idea that money damages can make a plaintiff whole to the extent injured (e.g., tort causes of action), disappointed (e.g., breach of contract causes of action and denial of other vested rights), or wrongfully treated (e.g., actions against public entities, for civil rights violations, or denial of benefits). Therefore, civil legal cases have economic value. Except for rare cases in which injunctive relief is the only remedy sought, civil legal cases have monetary value to the extent they have legally viable and factually provable claims for compensatory damages, punitive damages, attorney fees, and/or costs.

Although most civil legal actions are settled before trial, many cases result in a judgment. The judgment usually awards money to at least one of the litigants for compensatory damages, punitive damages, attorney fees, and/or costs. However, the value of a civil legal case that has resulted in a judgment is not accurately represented by the amount of money specified in the judgment, or any complaint, or any other document filed in court. The main reason for this is that any party disappointed by the judgment has the right to appeal. Appeals are often expensive, time consuming, and governed by rules that few attorneys understand.

Civil legal cases can have substantially different economic valuations before they are filed, after they are filed but before a judgment, after a judgment and on appeal, and after appeal but before a retrial. The analysis to determine present value is different for each stage. For instance, the analysis for civil legal cases prior to judgment is different for a civil legal case after a judgment because of the differences in rules of legal procedure.

Parties involved in civil legal action may attempt to negotiate with other parties before filing, during trial court proceedings, and/or while on appeal. Settlements can require extensive negotiation, much of which depends on evaluation of multiple possible events and outcomes. These possible outcomes can quickly lead to difficulty in logical evaluation. Even among legal experts, few understand how to valuate the economic impact of appellate reversal rates, prejudgment and postjudgment interest, attorney-fee shifting provisions, local rules governing cost awards, and the time value of money.

Despite these challenges, parties are compelled at least to guess about case valuation in order to determine whether to file, settle, settle in part, abandon, or continue with the litigation. Even so, few attorneys or lay people can engage in any logical valuation of a case—most rely on hunches, anecdotes, personal history, and speculation. Most attorneys who handle civil legal cases never engage in a quantitative analysis to determine present value by taking into account different outcomes with correspondingly different odds and dollar values. Instead, vague estimates substitute for any logical process to determine the present value of a case. However, there is a great need to determining the value of a civil legal case on appeal. The present invention may be implemented in a system and computer implemented process for determining the value of a civil legal case without requiring a legal education, degree in finance, or advanced mathematics skills.

As the number of motions, legal rulings, and findings of fact increases, combinations of attributes and attribute values that are involved in future success or failure become more complex.

The implementation disclosure presented here provides a tool for rational, visual, quantitative analysis of what a civil legal case is worth. The implementation described in this specification also eliminates probability theory pitfalls, such as that which occur by dividing the litigation into separate hearings or motions, even though the probable outcomes of most hearings and motions have high correlation to each other. Although most attorneys think of hearings and motions as separate events, for purposes of valuation they must be separated into causally independent events.

### SUMMARY OF THE INVENTION

The described subject matter can be implemented in a system and computer implemented method which produces an interactive valuation experience. Decision-tree analysis works well when applied in the litigation context as implemented by the present method because cases have multiple possible outcomes, each with differing odds of occurrence and gain or loss associated with the outcome, as well as varying expenses depending on the extent of litigation.

A decision tree is a decision support tool that uses a tree-like model of decisions and their possible consequences. A decision tree is a way to graphically display a computer implemented algorithm. Decision trees can be graphically represented as flowchart-like structures in which internal nodes represent a test on an attribute, and each branch from a node represents a possible outcome. In decision analysis, a decision tree and influence diagram are used as a visual and analytic decision support tool, where the expected values of potential alternatives are computed

For clarity and ease of reference, the following definitions are set forth in this specification. To the extent a term used in a claim is not defined below, it should be given the broadest possible definition persons in the pertinent art have given that term as reflected in at least one printed publication or issued patent.

“Civil legal action” means any claim for relief filed in a court or adjudicatory body that does not involve criminal prosecution, restriction of liberty based on dangerousness or mental infirmity, or termination of parental rights initiated by a governmental entity.

“Plaintiff” means any person or entity requesting relief in a court or adjudicatory body.

“Defendant” means any person or entity opposing the relief claimed by plaintiff in a court or adjudicatory body.

“Cross-plaintiff” means any defendant who has a legal claim against plaintiff for which relief is requested and that does not depend on the claim advanced by plaintiff against defendant.

“Cross-defendant” means any plaintiff opposing the relief requested by cross-plaintiff in a court or adjudicatory body.

“Issue of law” refers to the legal viability of a claim that does not depend on witness credibility, document authenticity, or persuasiveness of the evidence.

“Question of fact” refers to any determination by trier of fact (whether judge, jury, or tribunal) regarding the veracity of testimony, persuasiveness of evidence, and relative weight of evidence introduced during a trial or hearing.

“Judgment” includes any judgment, order, or ruling by a court or adjudicatory body that may be appealed to a higher court or adjudicatory body having power to affirm, reverse, or modify.

“Appeal” includes any request or demand to review, change, substitute, and/or modify a judgment that was entered or made by another court, adjudicatory body, or tribunal.

“Appellant” means any person or entity requesting in a court or adjudicatory body the reversal or modification of the judgment.

“Respondent” means any person or entity opposing the request in any court or adjudicatory body for reversal or modification of the judgment. “Respondent” includes any person designated “appellee” in the United States Courts of Appeals and any other adjudicatory body using the term “appellee.”

“Affirmance” means a decision by an appellate court to keep the judgment intact.

“Modification” means a decision by an appellate court to change the judgment without need for further proceedings in the lower court or adjudicatory body.

“Reversal” means a decision by an appellate court to vacate or set aside a judgment, usually with the need for further proceedings or retrial in the lower court or adjudicatory body.

“Attorney fees” means compensation and reimbursement for the person or entity providing representation or services to advance or defend legal claims.

“Costs” refers to expenses that court rules or other legal authority allow to be shifted to another party for advancing or defending a claim. Such expenses often include document production, filing fees, expert witness fees, and the expenses of producing tangible evidence. Costs do not include attorney fees.

“And/or” placed between two entities means either one of the two entities, or both entities. Multiple entities listing with “and/or” should be construed as “one or more” of the entities so conjoined.

“Example” is used to mean “serving as an example, instance, or illustration.” “Example” is not necessarily to be construed as preferred or advantageous over other embodiments.

“Machine-readable medium” refers to a medium that participates in directly or indirectly providing signals, instructions and/or data. It may take many forms, not limited to non-volatile media (ROM, disk) and volatile media (RAM), floppy or hard disk, magnetic tape, optical medium, memory chip or card or stick, and other media from which a computer, or processor, or other electronic device can read.

“Computer readable medium” includes any medium or mechanism for storing or transmitting information in machine-readable form, such as a computer (machine and computer are used synonymously herein).

The systems and methods described herein provide results allowing for insights beyond mere economic valuation. Specifically, they show how likely and/or unlikely parties are to succeed, estimate how much such a particular outcome is worth, estimate how long it will take for the process to conclude, reveal hidden assumptions conveyed in settlement offers, and to train in the decision-tree theory valuation process. The system and methods described herein are applicable, but not limited, to nearly every civil legal case before a state and/or federal court, other adjudicatory body such as administrative agency and internal adjudicatory process, and military courts. Thus, the system and methods of this process offers benefits to litigants, attorneys, investors, auditing companies, reporting agencies, legal periodicals, mediators, neutrals, arbitrators, judges, scholars, and persons with law- or policy-making responsibilities.

One aspect of the described subject matter can be implemented in methods that include at least one data processing device generating a decision tree to show the flow of litigation to possible outcomes based on whether the valuation pertains to a case before judgment, after judgment, or for the entirety of a case before and after judgment. This provides a visual roadmap to the litigation. In one embodiment, the process can be illustrated to show which branches lead to success and which to loss. For defendants, it can be eye-opening that the litigation is nothing but a process of economic loss even with a favorable jury verdict. For plaintiffs, they can learn that the paths to wins may be less numerous than to loss.

The valuation for each outcome resulting from issues of law terminating the litigation is computed based on percentage odds of prevailing and dollar amounts expected to be gained or lost in the following categories: scope of attorney fees and costs relating to issues of law. The valuation of each outcome for issues of law branches is adjusted by adding the expense of attorney fees and costs expended on establishing or defeating the legal viability of claims, based on whether attorney fees and costs are reciprocal, one-way shifting, or not subject to any shifting. The valuation of each outcome for issues of law is adjusted to account for prejudgment and/or postjudgment interest expended during the time required to establish or defeat the legal viability of claims. The valuation of each outcome for issues of law is adjusted to account for the discount rate as applied to the remainder of the time period until final resolution. The valuation is computed for each outcome resulting from questions of fact resolving issues related to witness credibility, document authenticity, relative weights of evidence, and other issues going to evidentiary proof, including high, low, and other applicable estimates of money damages. The valuation is adjusted for each outcome for questions of fact to account for the expense of attorney fees and costs expended to prove or disprove factual claims, taking into account whether attorney fees and costs are reciprocal, one-way shifting, or not subject to any shifting. The valuation is adjusted for each outcome relating to questions of fact to account for prejudgment and/or postjudgment interest on money damages corresponding to the time required to prove or disprove factual claims. The valuation is adjusted for each outcome relating to resolution of questions of fact to account for the discount rate as applied to the remainder of the time period until final resolution. The final expected value is computed as the sum of adjusted values of all possible outcomes.

The disclosure allows for computation of quite complex cases—such as those involving plaintiffs, cross-defendants, defendants, and cross-plaintiffs. The user can also change input data to compare different scenarios. The difference in intermediate and final computations may be computed based on revised, different, or additional data input from one or more users collaborating on valuation over a data or internet connection. The resulting computation and decision trees may be transmitted, printed, and/or otherwise rendered with a transitory or non-transitory display of the decision tree, intermediate and final computations, and timeline.

Other implementations of this aspect include corresponding systems, apparatuses, and computer programs configured to perform the actions of the methods and encoded on computer storage devices.

Particular implementations can realize one or more of the following advantages. For example, the disclosed method allows loss-averse users to forego the monetary valuation details to determine their odds of winning or losing. In yet another embodiment, the disclosed method allows users who experience high emotional costs as a result of litigation to determine how much longer they can expect the case to go on. In yet another embodiment, the disclosed method allows users to uncover the hidden or unstated assumptions underlying settlement offers.

In another implementation, the disclosed method facilitates communication of case valuation to persons in remote locations. In another implementation, the disclosed method allows users in remote locations to collaborate on risk analysis for a case. Thus, remote clients, insurance adjusters, co-counsel, and mediators can collaborate in ascertaining the economic value of a case. The result allows for informed discussion of whether to initiate, continue, or abandon litigation between attorneys, clients, insurance adjusters, stake-holders in the litigation, opposing parties and attorneys, mediators, third-party negotiators, arbitrators, and judges. The disclosed method allows for computation of whether the amount in controversy for the case suffices to justify litigation expenses and prospects for success. The disclosed method also allows litigants and investors to determine whether to sell the claims to the litigation. Lawyers can determine whether the prospects for litigation are sufficiently favorable to take the case on a contingency fee arrangement.

In another implementation, the disclosed method determines the impact of prejudgment and postjudgment interest. These statutory interest provisions frequently equal or exceed ten percent per annum and make a large difference in final expected value. Policy makers too can consider whether the magnitude of statutory interest provisions are consistent with the public policies underlying them.

The disclosed method also allows ratings agencies, investors of entities subject to litigation, banks guaranteeing loans and obligations for parties to litigation, auditors, certified public accountants, and experts in valuation to formulate and report objective values for the litigation. Insurance companies and other institutions supplying insurance, guarantees, and indemnity can evaluate categories of claims by using averages to formulate expected large-scale results, high estimates for extreme losses, and best case scenarios based on low-estimates. Companies can set up loss-reserve funds based on objective criteria rather than hunches.

Relying on the visual display and final computations of the disclosed method, parties may be able to negotiate for pricing of legal services, legal professionals may demonstrate their value to clients, mediators may show the value of compromise and their services, opposing parties may show that their own settlement offers and demands are reasonable and those of the other parties are unreasonable or irrational. In negotiations which resolve the vast majority of civil legal cases, the disclosed method offers a powerful tool to valuate demands and offers, and to show that the other parties demands must be adjusted or discounted. When parties are negotiating over settlements, the invention is useful at breaking impasse when one party clings to a demonstrably unjustified demand or offer. Mediators, parties, and attorneys can use high and low estimates to anticipate what the opening settlement offers might be and thereby where most of the negotiating difficulty will occur.

The disclosed method shows the impact of fee-shifting on final expected value. This can inform whether to draft an agreement with or without a fee-shifting agreement in the first place. Policy makers can determine whether to enact fee-shifting statutes and rules. Industry groups can ascertain whether to support or oppose fee-shifting statutes and rules. Litigants are able to show to courts whether the impact of fee-shifting furthers or hinders the public policy underlying the claims.

The disclosed method also allows users of legal processes who are familiar with trial court rules and procedures to analyze appellate outcomes and expectations without having to learn about appeals. Moreover, parties can determine whether it is cost-effective to hire an appellate expert, who though new to the case and therefore more expensive, sufficiently raises the prospects for success to justify the expense.

In another embodiment, the disclosed method allows the user to “reverse engineer” a settlement or settlement offer by starting with the final expected value. By either estimating chances of success or the likely high and low case outcomes at trial, the user is presented with estimates of what the offering party assumes to be the likely outcome of trial or the odds of success. In yet another embodiment, the user can enter the settlement or settlement offer and enter the odds of success and expected jury or bench trial result, the differential is then computed as the offering party's risk aversion. This risk aversion represents the quantitative valuation of the offering party's fear for loss of money, reputation, opportunities lost, or emotional cost.

In another embodiment, the disclosed method allows users to learn about how to do the analysis for themselves and provides quizzes to see whether they have mastered the skills necessary for case valuation.

### BRIEF DESCRIPTION OF THE DRAWINGS

FIG. 1 is a block diagram of an online environment in which a computer process with data connectivity among computing devices, printers, and/or remote servers engages in the valuation, display, sharing, and printing of the process.

FIG. 2 is a block diagram of an example decision tree for prejudgment case or dispute valuation.

FIG. 3 is a block diagram of an example valuation addition and final expected value display.

FIG. 4 is a block diagram of an example decision tree for a case proceeding to trial and appeal.

FIG. 5 is a block diagram of an example decision tree for a case on appeal.

FIG. 6 is a block diagram of an example decision tree for a case in trial court with a complaint and a cross-complaint.

FIG. 7 is a block diagram of an example valuation addition for a case in trial court with a complaint and cross-complaint.

FIG. 8 is a block diagram of example decision trees for an appeal and a cross-appeal in the appellate court.

FIG. 9 is a block diagram of an example valuation addition for an appeal and cross-appeal in the appellate court.

FIG. 10 is a flow chart of an example process for valuing civil legal cases and disputes.

### DETAILED DESCRIPTION

To the extent the descriptions stated here may appear specific to a particular embodiment or a particular use, this is intended to be illustrative only and is not to be construed as limiting the scope of the invention. On the contrary, it is intended to cover all alternatives, modifications, and equivalents that may be included within the spirit and scope of the invention.

Some portions of the detailed description which follows are presented in terms of procedure, steps, processing, and other symbolic representations of operations carried out in a computing system or a computing device. These descriptions and representations are the means used by those skilled in the data processing arts to most effectively convey the substance of their work to others skilled in the art. In this detailed description, a procedure, step, process, or the like, is conceived to be a self-consistent sequence of steps or instructions leading to a desired result. The steps are those requiring physical manipulations of physical quantities. Usually, although not necessarily, these quantities take the form of electrical, magnetic, or optical signals capable of being stored, transferred, combined, compared, and otherwise manipulated.

Unless specifically stated otherwise, terms such as generating, computing, adjusting, displaying, adjusting, identifying, valuating, valuing, comparing, and the like, may refer to the action and processes of a computer system, or other electronic device, that process data represented as physical (electronic, magnetic, or optical) quantities within some electrical device's storage, transmission, or display devices. These and similar terms are merely convenient labels, however, they are to be associated with the appropriate physical processes.

Embodiments disclosed herein also relate to apparatuses for performing the operations herein. Such apparatuses may be specially constructed for the required purposes, or may comprise general-purpose computers selectively activated or reconfigured by computer program or code. Such a computer program or code may be stored or encoded in a computer readable medium or implemented over a data transmission medium.

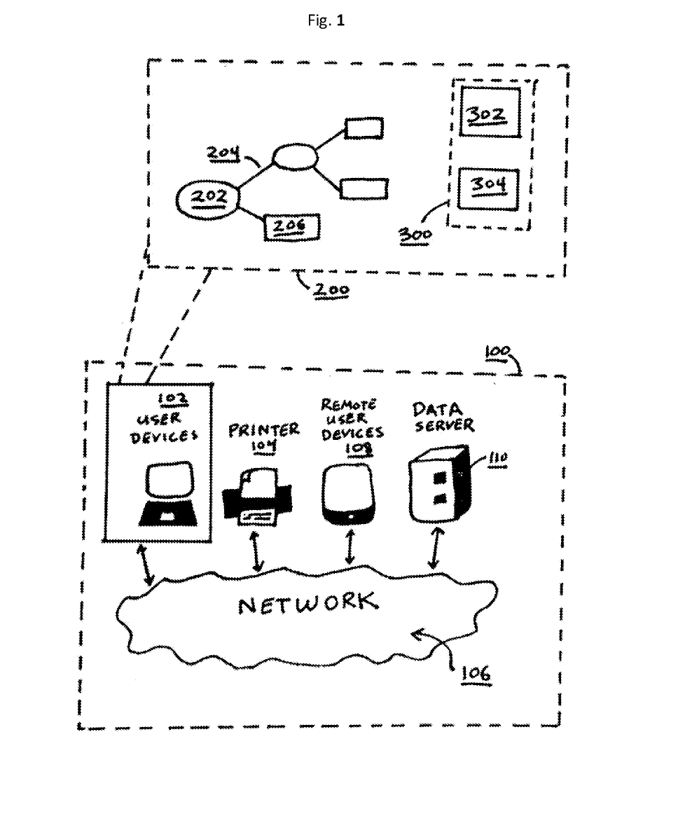

FIG. 1 illustrates an exemplary system architecture in which civil legal cases are valuated in an online computer environment 100. In one example system, a computing device 102 with data connectivity to a network 106 may compute the valuation 200, 400, 500, 600 and/or 800, or display the process computed on another device 108 or server 110. The user's computing device 102 may be any computer, mobile electronic device, any device capable of transmitting and/or receiving data, or electronic display device with user input. The user device 102 may have, but does not need, data connectivity with a network 106 to carry out the valuation process. If the computing device 102 is connected to the network 106, the system allows multiple users 102 and 108 to share example decision trees 200, 400, 500, 600 and/or 800 and/or results 304, 706, or 906 of the process. The process also allows a user to transmit the results of the process to a printer 104 for ease of reference or use in meetings such as in negotiations, mediations, or conferences with clients or investors.

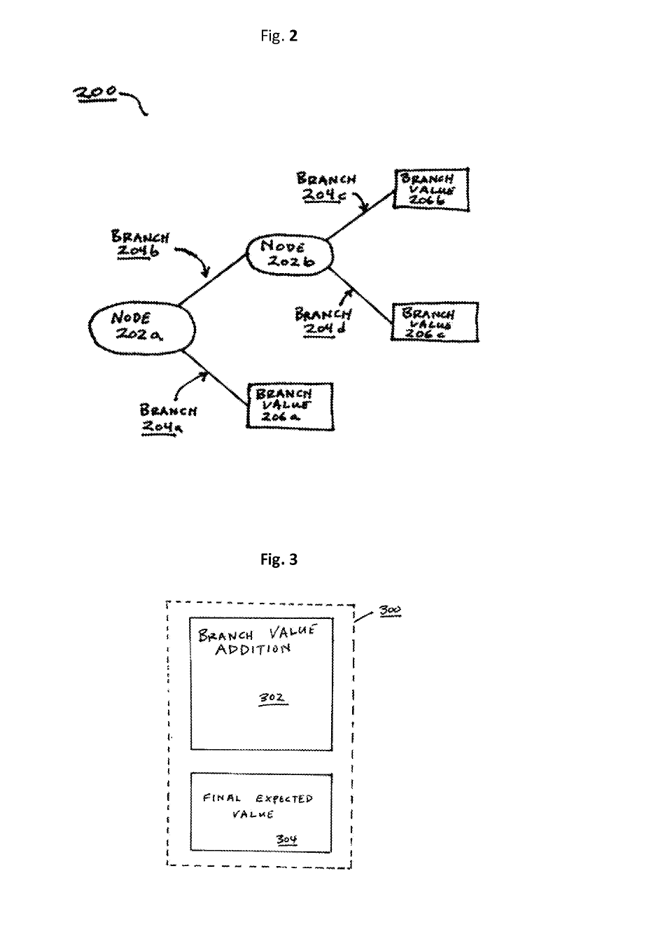

FIG. 2 is an exemplary diagram of a computer implemented process (conducted on the user's computing device 102 and/or 108) for valuing a civil legal case prior to trial or a case before an appealable order or final judgment is filed. To generate a decision tree, data from a query is processed in 102 and/or 108 to determine necessary nodes such as 202a and 202b. Example query data trains the model system to determine whether the valuation is for a case before judgment, or after entry of judgment, or an appealable order.

The process set forth in this specification divides the nodes into causally independent factors to eliminate statistical miscalculation. Moreover, the division between issues of law and questions of fact is itself drawn by the trial and appellate courts, and is thus a division amenable to easy identification and analysis in nodes 202a and 202b. Similarly, the process values cases on appeal (which are limited to questions of law) in a complete analytic manner accounting for the strengths and weaknesses of the entire case by separating the issues of law (the appeal) 202a from the questions of fact (retrial) 202b. Moreover, this process accounts for potentially large impacts on valuation, 206a, 206b, 206c, such as attorney fees, costs, prejudgment and postjudgment interest, as well as the expenses of legal motions and evidentiary proof. Those unfamiliar with the legal process will usually fail to appreciate the large difference in case value these factors have.

If the valuation is for a case prior to judgment, the process queries whether the analysis is for plaintiff or defendant, the maximum damages award (without attorney fees, costs, or interest), the minimum damages award (which may be zero, but may be a negative number in the event of court sanctions), the total cost to litigate the legal viability of plaintiff's claims, the percentage odds of success in prevailing on legal liability issues, the total cost to prove or disprove plaintiffs factual claims (including discovery, depositions, and trial), the percentage odds of success in proving the high and the low estimate. The process ensures that the user's estimates of odds of success for the high and low add up to 100 percent. The process queries whether there is a fee-shifting provision to be applied to the attorney fees, and if so, whether it is reciprocal, one-way to the plaintiff, or one-way to defendant. The process queries whether to account for prejudgment interest, what the rate is, and how long before or after the start of the action the prejudgment begins to accrue. The process queries how long it will take to resolve the legal viability of the claim, and then after that how long until trial resolves the questions of fact. The process queries whether to compute the time value of money using a specified discount rate (to avoid equation of valuable current dollars for less valuable future dollars).

As an example, to compute case value for plaintiffs before appealable order or final judgment, the FIG. 2 illustrates a model process which rendered the decision tree 200 with nodes 202a and 202b along with branches 204a-204c.

For plaintiffs, the process computes 206a the sum of monetary award (most likely zero for a defense verdict or negative if plaintiff also incurs sanctions); attorney fees and costs for legal issue determination multiplied by percentage odds as loss. If user has selected reciprocal fee shifting, the process doubles attorney fees because plaintiff must reimburse defendant and pay his or her own; if one-way fee shifting to defendant the process also doubles attorney fees, if one-way to plaintiff the process makes no adjustment.

For plaintiffs, the process computes 206b the high estimate of the monetary award multiplied percentage odds (comprised of percentage odds in succeeding on legal issues multiplied by the percentage odds of succeeding at trial), and show as a gain. The process computes as a loss the product of attorney fees and costs for both legal issues and trial, multiplied by the percentage odds (comprised of percentage odds in succeeding on legal issues multiplied by the percentage odds of succeeding at trial). For 206b, if user has selected reciprocal fee shifting, the process sets the attorney fees value to zero (because plaintiff is reimbursed); if one-way fee shifting to plaintiff, the process sets the attorney fees value to zero; if one-way fee shifting to defendant, makes no adjustment. The process computes as a gain, the prejudgment interest (judgment amount multiplied by the number of years it takes to judgment, which consists of time to decision on legal issues plus time to trial) by the percentage odds (comprised of percentage odds in succeeding on legal issues multiplied by the percentage odds of succeeding at trial).

For plaintiffs, the process computes 206c the low estimate of the monetary award (likely to be zero, in the event of a defense verdict) multiplied by percentage odds (comprised of percentage odds in succeeding on legal issues multiplied by the percentage odds of succeeding at trial). Show as a loss the attorney fees and costs incurred for both legal issues and trial multiplied by the percentage odds (comprised of percentage odds in succeeding on legal issues multiplied by the percentage odds of succeeding at trial). For 206c, if user has selected reciprocal fee shifting, the process doubles the attorney fees because plaintiff must reimburse defendant and pay his or her own attorney fees; if one-way fee shifting to plaintiff, the process sets the attorney fees value to zero; if one-way fee shifting to defendant the process doubles the attorney fees because plaintiff has lost at trial. If recovery is any amount more than zero (a defense judgment) the process computes as a gain, the prejudgment interest (judgment amount multiplied by the number of years it takes to judgment, which consists of time to decision on legal issues plus time to trial) by the percentage odds (comprised of percentage odds in succeeding on legal issues multiplied by the percentage odds of succeeding at trial).

FIG. 3 refers to valuation computation, which for plaintiffs corresponds to, in 302, the sum of all branches, namely 206a to 206c. The process displays the output of 302 (branch value addition) in 304 (final expected value) with the expected case value from this litigation to plaintiff.

For plaintiffs, the process queries whether to change any entered values 1004 to 1008 to explore alternate scenarios. The process queries whether to print 1020 with full decision tree, computations, branch results and final expected case value. The process may print 1020 with only decision trees and no values filled in. The process may generate an alternate display 200 showing no dollar values but percentage odds of ultimate success (using same computations as for final expected value, except without dollar values) 304. The process may display 200 time to final result alone (without odds of success or dollar values) by simply adding time of determining legal liability plus time from that determination to time required to trial as input by user 1004 and 1006. The process may electronically transmit 106 full decision tree 200 with or without numerical values and computations to a remote user 108. The process allows remote user 108 to collaborate and change values via network connection 106.

As another example, to compute case value for defendant before appealable order or final judgment, the process renders the decision tree 200 with nodes 202a and 202b along with branches 204a-204c. For defendants, the process computes 206a as the sum of the monetary award (likely zero, but negative in the event of sanctions imposed on plaintiff); attorney fees and costs for legal issue determination multiplied by percentage odds as a loss. If user has selected reciprocal fee shifting, the process eliminates the attorney fees because plaintiff must reimburse defendant, but if one-way shifting to plaintiff make no adjustment.

For defendants, the process computes 206b as the high estimate of the monetary award multiplied percentage odds (comprised of percentage odds in succeeding on legal issues multiplied by the percentage odds of succeeding at trial), and show as a loss. The process computes as a loss the attorney fees and costs incurred for both legal issues and trial multiplied by the percentage odds (comprised of percentage odds in succeeding on legal issues multiplied by the percentage odds of succeeding at trial). For 206b, if user has selected reciprocal fee shifting, the process doubles attorney fees because defendant must bear own attorney fees and reimburse plaintiff; if one-way fee shifting to plaintiff, the process also doubles attorney fees; if one-way fee shifting to defendant, the process makes no adjustment. The process computes as a loss, the prejudgment interest (judgment amount multiplied by the number of years it takes to judgment, which consists of time to decision on legal issues plus time to trial) by the percentage odds (comprised of percentage odds in succeeding on legal issues multiplied by the percentage odds of succeeding at trial).

For plaintiffs the process computes 206c as the low estimate of the monetary award (probably zero to account for a defense verdict) multiplied percentage odds (comprised of percentage odds in succeeding on legal issues multiplied by the percentage odds of succeeding at trial). The process computes as a loss the attorney fees and costs incurred for both legal issues and trial multiplied by the percentage odds (comprised of percentage odds in succeeding on legal issues multiplied by the percentage odds of succeeding at trial). For 206c, if user has selected reciprocal fee shifting, the process eliminates the attorney fees because plaintiff must reimburse defendant; if one-way fee shifting to plaintiff, the process makes no adjustment; if one-way fee shifting to defendant the process eliminates attorney fees. If recovery is any amount more than zero (a defense judgment) the process computes as a loss, the prejudgment interest (judgment amount multiplied by the number of years it takes to judgment, which consists of time to decision on legal issues plus time to trial) by the percentage odds (comprised of percentage odds in succeeding on legal issues multiplied by the percentage odds of succeeding at trial).

For defendants, the process computes in 302 the sum of all branches, namely 206a to 206c. Display the output of 302 (branch value addition) in 304 (final expected value) to see the expected case value from this litigation to defendant.

For defendants, the process queries whether to change any entered values 1004 to 1008 to explore alternate scenarios. The process queries whether to print 104 with full decision tree, computations, branch results 302 and final expected case value 304. The process may print 104 with only decision trees and no values filled in. The process may generate an alternate display 200 showing no dollar values but percentage odds of ultimate success (using same computations as for final expected value, except without dollar values) 304. The process may display 200 time to final result alone (without odds of success or dollar values) by simply adding time of determining legal liability plus time from that determination to time required to trial as input by user 1004 and 1006. The process may electronically transmit 106 full decision tree 200 with or without numerical values and computations to a remote user 108. The process allows remote user 108 to collaborate and change values via network connection 106.

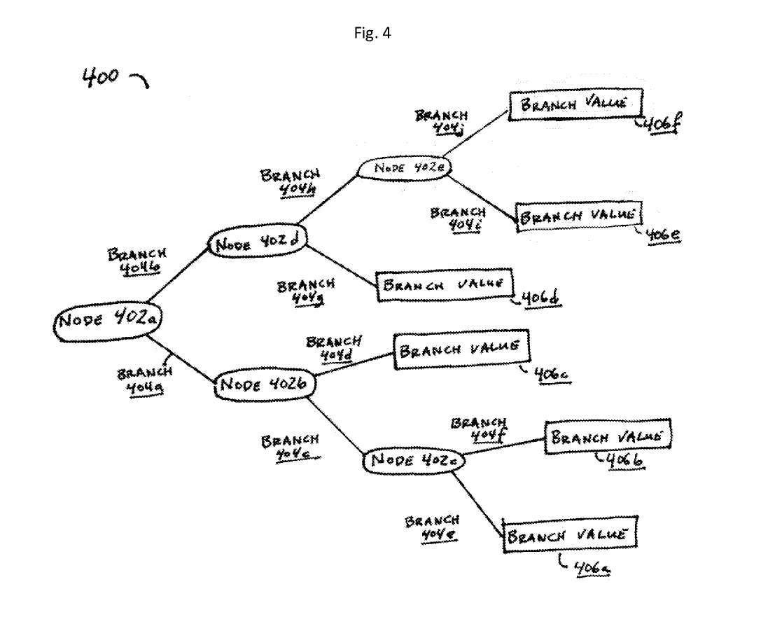

FIG. 4 provides an example valuation 400 for full litigation of a case before and after entry of judgment—for plaintiff in a case in which plaintiff is willing to see the case only through trial, but the opposing party is willing to take the case both through trial and through appeal. The process renders the decision tree 400 with nodes 402a to 402e along with branches 404a-404e.

For plaintiff's full-case valuation, the process computes 406a as: ((high monetary award) minus (attorney fees and costs for determination of legal viability and attorney fees and costs for trial)) multiplied by ((percentage odds of losing on legal viability issues) multiplied by (percentage odds of succeeding on appeal) multiplied by (percentage odds of succeeding at trial)). If user has selected reciprocal fee shifting, the process eliminates attorney fees and costs because defendant must reimburse plaintiff. If one-way fee shifting to defendant, the process does not adjust attorney fees. If one-way to plaintiff, the process eliminates attorney fees and costs.

For plaintiff's full-case valuation, the process computes 406b as: ((low monetary award) minus (attorney fees and costs for determination of legal viability and attorney fees and costs for trial)) multiplied by ((percentage odds of losing on legal viability issues) multiplied by (percentage odds of winning on appeal) multiplied by (percentage odds of losing at trial)). If user has selected reciprocal fee shifting, the process doubles attorney fees and costs because plaintiff must reimburse defendant under this worst-case scenario. If one-way fee shifting to defendant the, process also doubles attorney fees and costs. If one-way to plaintiff, the process makes no adjustment.

For plaintiff's full-case valuation, the process computes 406c as: (attorney fees and costs for determination of legal viability and attorney fees for appeal) multiplied by ((percentage odds of losing on legal viability issues) multiplied by (percentage odds of losing on appeal)). If user has selected reciprocal fee shifting, the process doubles attorney fees and costs because plaintiff must reimburse defendant under this worst-case scenario. If one-way fee shifting to defendant, the process doubles attorney fees and costs. If one-way to plaintiff, the process makes no adjustment.

For plaintiff's full-case valuation, the process computes 406d as: ((low monetary award) minus (attorney fees and costs for determination of legal viability and attorney fees and costs for trial)) multiplied by (percentage odds of succeeding on legal viability issues multiplied by percentage odds of losing at trial)). If user has selected reciprocal fee shifting, the process doubles attorney fees and costs because plaintiff must reimburse defendant under this worst-case scenario; if one-way fee shifting to defendant the process doubles attorney fees and costs, if one-way to plaintiff the process makes no adjustment.

For plaintiff's full-case valuation, the process computes 406e as: ((zero judgment award after losing appeal minus (attorney fees and costs for determination of legal viability and attorney fees and costs for trial)) multiplied by ((percentage odds of succeeding on legal viability issues) multiplied by (percentage odds of winning at trial) multiplied by percentage odds of losing on appeal)). If user has selected reciprocal fee shifting, the process doubles attorney fees and costs because plaintiff must reimburse defendant under this worst-case scenario; if one-way fee shifting to defendant also the process doubles attorney fees and costs, if one-way to plaintiff the process makes no adjustment.

For plaintiff's full-case valuation, the process computes 406f as: ((high monetary award affirmed on appeal) minus (attorney fees and costs for determination of legal viability and attorney fees and costs for trial)) multiplied by ((percentage odds of succeeding on legal viability issues) multiplied by (percentage odds of winning at trial) multiplied by percentage odds of losing on appeal)). If user has selected reciprocal fee shifting, the process eliminates attorney fees and costs because; if one-way fee shifting to defendant the process makes no adjustment, if one-way to plaintiff the process eliminates attorney fees.

For plaintiff's full-case valuation, the process computes the sum of all branches 302, namely 406a to 406f The process displays the branch value addition 302 as final expected value 304 to as the expected case value from this litigation to plaintiff.

For plaintiff's full-case valuation, the process queries whether to change any entered values 1004 to 1008 to explore alternate scenarios. The process may print 104 with full decision tree, computations, branch results and final expected case value. The process may print 104 with only decision trees and no values filled in. The process may generate an alternate display 200 showing no dollar values but percentage odds of ultimate success (using same computations as for final expected value, except without dollar values) 304. The process may display 200 time to final result alone (without odds of success or dollar values) by simply adding time of determining legal liability plus (time from that determination to time required to trial as input by user 1004 and 1006. The process may electronically transmit 106 full decision tree 200 with or without numerical values and computations to a remote user 108. The process allows remote user 108 to collaborate and change values via network connection 106.

As another example, a defendant's case in the trial court and then in the appellate court 400, may be valuated by the process 400 based on defendant's odds and expected dollar losses.

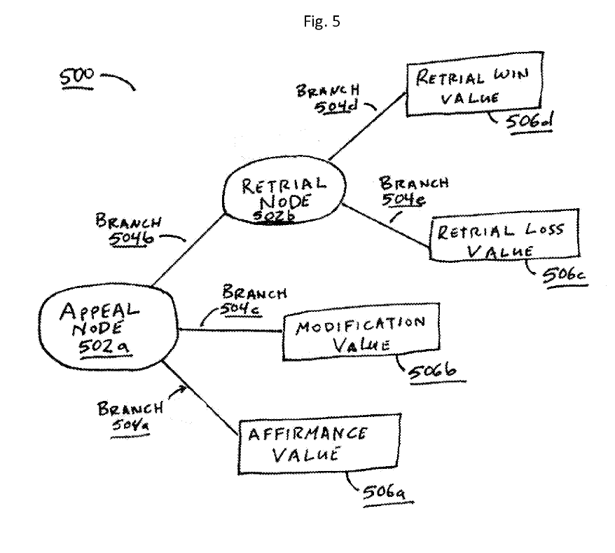

FIG. 5 refers to an example valuation for a case on appeal for appellant in which the process renders the decision tree 500 with nodes 502a and 502b along with branches 504a-504d.

For appellants, the process computes 506a (affirmance) as the sum of judgment award, plus attorney fees and costs for the appeal multiplied by percentage odds. Depending on the judgment, this may be a positive or negative value. If user has selected reciprocal fee shifting, the process doubles the attorney fees because appellant must reimburse respondent and pay his or her own; if one-way fee shifting to respondent the process doubles attorney fees, if one-way to appellant the process makes no adjustment.

For appellants, the process computes 506b (modification) as the sum of amount of the judgment as modified by the appellate court multiplied by percentage odds. Depending on the judgment, this may be a positive or negative value. The process ignores attorney fees because a modification may or may not change the prevailing party for purposes of attorney fees, which most likely cancel each other out on a probabilistic basis.

For appellants, the process computes 506c as the low estimate of the monetary award (probably zero, in the event of a defense verdict) to be expected on retrial, multiplied percentage odds (comprised of percentage odds in succeeding on appeal multiplied by the percentage odds of worst case scenario at retrial). The process computes as a loss the attorney fees and costs incurred for both the appeal and retrial multiplied by the percentage odds (comprised of percentage odds in succeeding on appeal multiplied by the percentage odds of worst case scenario at retrial). For 506c, if user has selected reciprocal fee shifting, the process doubles the attorney fees because this represents appellant's worst-case scenario under which appellant must reimburse respondent and pay his or her own attorney fees as well; if one-way fee shifting to appellant include only appellant's attorney fees; if one-way fee shifting to respondents the process doubles the attorney fees. If recovery is any amount more than zero (a defense judgment) show as a gain, the postjudgment interest (judgment amount multiplied by the number of years it takes from judgment to decision by the highest appellate court used for valuation purposes) by the percentage odds comprised of percentage odds in succeeding on appeal multiplied by the percentage odds of succeeding at retrial).

For appellants, the process computes 506d as the high estimate of the monetary award to be expected on retrial, multiplied percentage odds (comprised of percentage odds in succeeding on appeal multiplied by the percentage odds of succeeding at retrial). The process the process computes as a loss the attorney fees and costs incurred for both the appeal and retrial multiplied by the percentage odds (comprised of percentage odds in succeeding on appeal multiplied by the percentage odds of succeeding at retrial). For 506d, if user has selected reciprocal fee shifting, the process eliminates attorney fees and costs because respondent must reimburse appellant; if one-way fee shifting to appellant the process eliminates attorney fees and costs; if one-way fee shifting to respondents the process does not adjust appellant's attorney fees and costs. The process computes as a gain, the postjudgment interest (judgment amount multiplied by the number of years it takes from judgment to decision by the highest appellate court used for valuation purposes) by the percentage odds (comprised of percentage odds in succeeding on appeal multiplied by the percentage odds of succeeding at retrial).

For appellants, the process computes in 302 the sum of all branches, namely 506a to 506d. The process computes for the user the branch value addition 302 as final expected value 304 representing the expected case value from this litigation to plaintiff.

For appellants, determine whether user wishes to change any entered values 1004 to 1008 to explore alternate scenarios. Determine whether user wishes to print 104 with full decision tree, computations, branch results and final expected case value. The process may print 104 with only decision trees and no values filled in. The process may generate an alternate display 200 showing no dollar values but percentage odds of ultimate success (using same computations as for final expected value, except without dollar values) 304. The process may display 200 time to final result alone (without odds of success or dollar values) by simply adding time of appeal plus time to completion of retrial as input by user 1004 and 1006. The process may electronically transmit 106 full decision tree 200 with or without numerical values and computations to a remote user 108. The process allows remote user 108 to collaborate and change values via network connection 106.

As another example, the process computes case value for respondent after entry of an appealable order or final judgment by rendering the decision tree 500 with nodes 502a and 502b along with branches 504a-504d.

For respondents, the process computes 506a (affirmance) as the sum of judgment award, plus attorney fees and costs for the appeal multiplied by percentage odds. Depending on the judgment, this may be a positive or negative value. If user has selected reciprocal fee shifting, the process eliminates the attorney fees because appellant must reimburse respondent and pay his or her own; if one-way fee shifting to respondent the process eliminates attorney fees, if one-way to appellant the process makes no adjustment.

For respondents, the process computes 506b (modification) as the product of amount of the judgment as modified by the appellate court multiplied by percentage odds. Depending on the judgment, this may be a positive or negative value. The process ignores attorney fees because a modification may or may not change the prevailing party for purposes of attorney fees, which then most likely cancel each other out on a probabilistic basis.

For respondents, the process computes 506c as the low estimate of the monetary award (probably zero, in the event of a defense verdict) to be expected on retrial, multiplied percentage odds (comprised of percentage odds in losing on appeal multiplied by the percentage odds of succeeding at retrial). The process computes as a loss the attorney fees and costs incurred for both the appeal and retrial multiplied by the percentage odds (comprised of percentage odds in losing on appeal multiplied by the percentage odds of succeeding at retrial). For 506c, if user has selected reciprocal fee shifting, the process eliminates the attorney fees because this represents appellant's worst-case scenario under which appellant must reimburse respondent and pay his or her own attorney fees as well; if one-way fee shifting to appellant leave attorney fees unadjusted; if one-way fee shifting to respondents the process eliminates the attorney fees. If recovery is any amount more than zero (a defense judgment) the process computes as a loss, the postjudgment interest (judgment amount multiplied by the number of years it takes from judgment to decision by the highest appellate court used for valuation purposes) by the percentage odds (comprised of percentage odds in losing on appeal multiplied by the percentage odds of succeeding at retrial).

For respondents, the process computes 506d as the high estimate of the monetary award to be expected on retrial, multiplied percentage odds (comprised of percentage odds in losing on appeal multiplied by the percentage odds of losing at retrial). The process computes as a loss the attorney fees and costs incurred for both the appeal and retrial multiplied by the percentage odds (comprised of percentage odds in succeeding on appeal multiplied by the percentage odds of succeeding at retrial). For 506d, if user has selected reciprocal fee shifting, the process doubles the attorney fees and costs because respondent must reimburse appellant; if one-way fee shifting to appellant the process doubles attorney fees; if one-way fee shifting to respondents the process does not adjust attorney fees. The process computes as a loss, the postjudgment interest (judgment amount multiplied by the number of years it takes from judgment to decision by the highest appellate court used for valuation purposes) by the percentage odds (comprised of percentage odds in losing on appeal multiplied by the percentage odds of losing at retrial).

For respondents, the process computes in 302 the sum of all branches, namely 506a to 506d. The process computes for the user the output of 302 (branch value addition) in 304 (final expected value) as the expected case value from this litigation to plaintiff.

For respondents, the process queries whether the user wishes to change any entered values 1004 to 1008 to explore alternate scenarios. The process queries whether user wishes to print 104 with full decision tree, computations, branch results and final expected case value. The process may print 104 with only decision trees and no values filled in. The process may generate an alternate display 200 showing no dollar values but percentage odds of ultimate success (using same computations as for final expected value, except without dollar values) 304. The process may display 200 time to final result alone (without odds of success or dollar values) by simply adding time of appeal plus time to completion of retrial as input by user 1004 and 1006. The process may electronically transmit 106 full decision tree 200 with or without numerical values and computations to a remote user 108. The process allows remote user 108 to collaborate and change values via network connection 106.

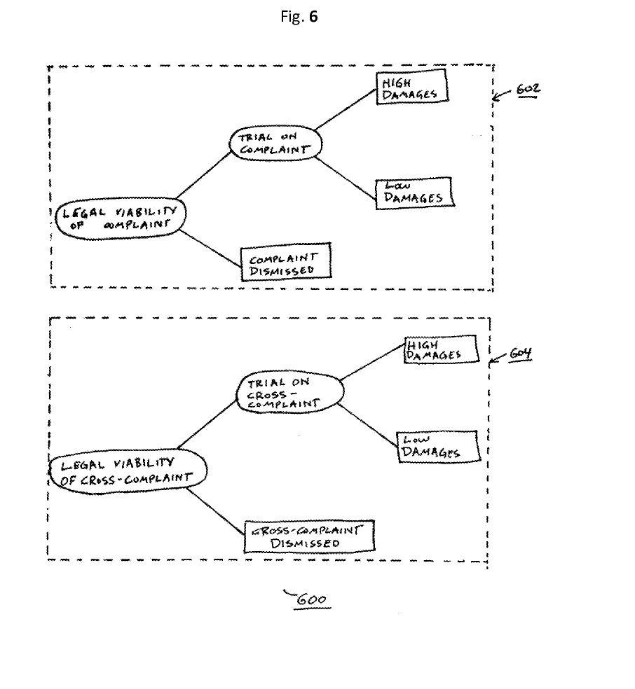

FIG. 6 refers to an example case valuation in which there exists an action (complaint by plaintiff) and at least one cross-action (cross-complaint(s) by cross-plaintiff(s)). To compute case value for plaintiffs who had filed a complaint and is being sued in the same action as cross-defendant the process computes the value of the full case 600 as follows. The process renders the decision tree 602, by computing for the complaint the decision tree 200 with nodes 202a and 202b along with branches 204a-204c. The process computes the value 702. The process renders the decision tree 604, by computing for the cross-complaint the decision tree 200 with nodes 202a and 202b along with branches 204a-204c. This will likely be a negative value 704.

As another example, the process computes case value for defendants who are being sued in a complaint and are suing plaintiff (as cross-defendant) in the same action as cross-plaintiff compute the value of the full case 600 by rendering the decision tree 602, and computing for the complaint the decision tree 200 with nodes 202a and 202b along with branches 204a-204c. This will likely be a negative value 702 for defendant. The process renders the decision tree 604, by computing for the cross-complaint the decision tree 200 with nodes 202a and 202b along with branches 204a-204c.

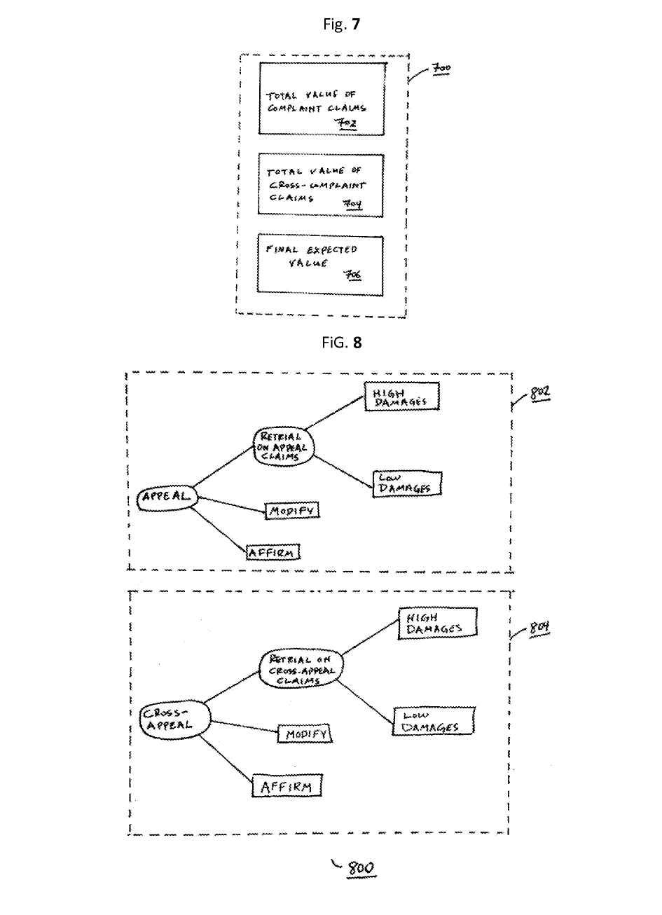

FIG. 7 refers to an example valuation computation illustrates the computation for an action and cross-action. The process combines the values of the complaint 702 with the value of the cross-complaint 704 to compute the final expected value 706.

FIG. 8 refers to an example valuation computation for appeal involving both appeal and cross-appeal. To compute case value for appellant who had filed an appeal but must also defend against a cross-appeal filed by respondent, the process computes the value of the full appellate proceeding 800 by rendering the decision tree 802, and by computing for the appeal the decision tree 500 with nodes 502a and 502d along with branches 504a-504d. The process renders the decision tree 804, by computing for the cross-appeal the decision tree 500 with nodes 502a and 502b along with branches 504a-504d. This will likely be a negative value 804.

As another example, the process computes case value for respondent who must defend against an appeal but also has him- or herself filed a cross-appeal 800, the process renders the decision tree 802, by computing for the appeal the decision tree 500 with nodes 502a and 502d along with branches 504a-504d. The process computes the value 902. The process renders the decision tree 804, by computing for the cross-appeal the decision tree 500 with nodes 502a and 502b along with branches 504a-504d. This may be a positive value 804 (more likely it will be a less negative value than in 902.

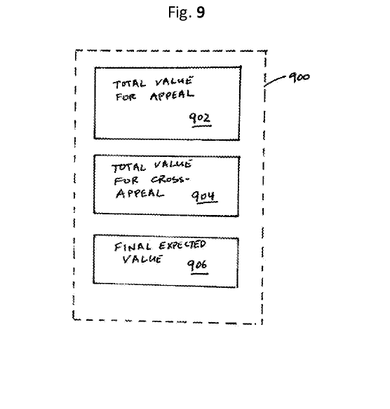

FIG. 9 refers to the computation of final expected value of a case involving an appeal and cross appeal. The process computes value of appeal 902 and cross-appeal 904. The process combines the values of the appeal 902 with the value of the cross-appeal 904 to compute the final expected value 906.

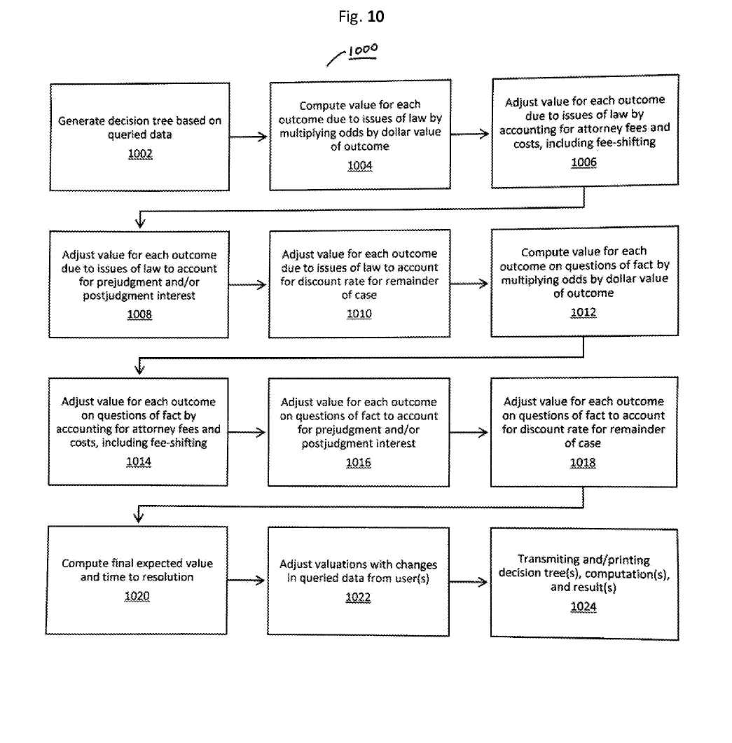

FIG. 10 is a flow chart of example processes 200, 400, 500, 600, and/or 800. In some implementations, the process 200, 400, 500, 600, and/or 800 can be implemented, for example, in the environment 100 of FIG. 1. In other implementations, the process 200, 400, 500, 600, and/or 800 can be implemented as instructions encoded on a computer readable medium that when executed cause a data processing device or system to perform operations of the processes 200, 400, 500, 600, and/or 800. The processes 200, 400, 500, 600, and/or 800, as described above, can correspond to and represent a removal or addition of a node and corresponding branches of a corresponding decision tree.

With reference to FIG. 10, the process generates a decision tree 200, 400, 500, 600, and/or 800 showing the flow of litigation to possible outcomes based on whether the valuation pertains to a case before judgment, after judgment, or for a case before and after judgment 1002. In other implementations, the decision tree will have fewer nodes, such as when the parties stipulate either to issues of law or issues of fact. In yet other implementations, the decision tree will have additional nodes to account for additional decision points, such as when there are multiple parties or the parties are each willing to see trial court litigation through one or more appeals and/or retrials.

The process computes the valuation for each outcome resulting from issues of law terminating the litigation based on percentage odds of prevailing and dollar amounts expected to be gained or lost in the following categories: scope of attorney fees and costs relating to issues of law 1004.

The process adjusts the valuation of each outcome for issues of law branches by adding the expense of attorney fees and costs expended on establishing or defeating the legal viability of claims, taking into account whether attorney fees and costs are reciprocal, one-way shifting, or not subject to any shifting 1006. In some implementations, the issues of law will yield negative values due to the expenses associated with attorney fees and costs. In some implementations, the valuation of issues of law will be zero as in cases in which representation is conducted on a pro bono basis. In some implementations, the attorney fees may be positive as in the case in which a party secures monetary sanctions for bad faith by an opposing party.

The process adjusts the valuation of each outcome for issues of law to account for prejudgment and/or postjudgment interest expended during the time required to establish or defeat the legal viability of claims 1008. In one implementation, prejudgment interest will be computed using the events giving rise to the claim through time of judgment. In other implementations, prejudgment interest will be determined for the time period as defined by applicable statute, rule, regulation, or case authority. In other implementations, postjudgment interest will apply to time periods following entry of judgment until satisfaction of judgment by the judgment debtor. In yet other implementations, prejudgment and postjudgment interest will be added to the valuation.

The process adjusts the valuation of each outcome for issues of law to account for the discount rate as applied to the remainder of the time period until final resolution 1010. In some implementations, the discount rate may be set to objective metrics such as the rate of inflation, consumer price index, treasury bill rates. In additional implementations, other investor discount rates may apply.

The process computes the valuation for each outcome resulting from questions of fact resolving issues related to witness credibility, document authenticity, relative weights of evidence, and other issues going to evidentiary proof, including high, low, and other applicable estimates of money damages 1012.

The process adjusts the valuation of each outcome for questions of fact to account for the expense of attorney fees and costs expended to prove or disprove factual claims, taking into account whether attorney fees and costs are reciprocal, one-way shifting, or not subject to any shifting 1014.

The process adjusts the valuation of each outcome relating to questions of fact to account for prejudgment and/or postjudgment interest on money damages applicable to the time required to prove or disprove factual claims 1016.

The process adjusts the valuation of each outcome relating to resolution of questions of fact to account for the discount rate as applied to the remainder of the time period until final resolution 1018.

The process computes the final expected value as the sum of expected, adjusted values of all possible outcomes 1020. In some instances, the final expected value will be positive, such as for a plaintiff when a plaintiff prevails on claims. In other instances, the final expected value will be negative as when a plaintiffs claims result in a defense judgment or for a defendant who incurs only expenses and/or losses.

The process computes difference in intermediate and final computations due to revised, different, or additional data input from one or more users collaborating on valuation over a data or internet connection 1022. In some implementations, the process shows the difference in expected values based on differing assumptions regarding odds of success and/or different fees, expenses, and/or monetary awards. In other implementations, repeated iterations of the process in a computing environment can show varying outcomes to illustrate which decision points have larger or smaller effects on the outcome. In other implementations, iterations of the process 1022 can allow for comparisons of outcomes resulting from assumptions by different users, opposing parties, and other interested persons.

The process transmits, prints, and/or otherwise renders a non-transitory display of the decision tree, intermediate and final computations, and timeline 1024. In one implementation, the process prints the intermediate and/or final calculated values. In another implementation, the process prints only partial values to allow persons to use the decision tree to negotiate, analyze, or confer with other persons, clients, investors, and/or parties. In another implementation, the process transfers the full or partial computations to a remote user in either transient or non-transient form. In yet another implementation, the process transmits the data, computations, and/or decision tree in an online environment 100 for data storage and remote retrieval.

The operations and computations described in this specification can be implemented in electronic circuitry, or in computer software, hardware, and/or firmware, including the structures disclosed in this specification and their equivalents. The operations and computations can also be implemented as one or more computer program products. The computer-readable medium can be a machine-readable storage device, a memory device, a composition of matter effecting a machine-propagated signal, or combination thereof. The processes and logical flows described in this specification can be carried out by a processor, or fractional processing power that when implemented constitutes an integrated system, that operate with data input and generating computational and/or display output.

Although this specification contains specifics and details, these disclosures should not be interpreted as limitations on what may be claimed, but rather serve as descriptions illustrating attributes of particular implementations. Certain features described in specific implementations can also be implemented in combination in a single implementation. Additional, features described in particular implementations may also be implemented in multiple implementations separately or in any suitable combination. Although operations and computations are depicted in the drawings in a particular order, this illustration should not be understood as requiring that such operations occur in a particular order or in sequential order, or that all illustrated operations and computations be performed to achieve the results. Moreover, separation of operations and computations in the drawings should not be understood to require separation in all implementations.

Thus, particular implementations have been described. Other implementations are within the scope of the following claims. For example, the actions recited in the claims can be performed in a different order and achieve alternate views and computations, each of which helps the user understand and value the litigation more fully.

What is claimed is:

1. A computer implemented method, comprising:
generating a decision tree for the flow of litigation to possible outcomes based on whether the valuation pertains to a case before judgment, after judgment, or for the entirety of a case before and after judgment, the type of case being identified by data input from a user device or server;
computing a valuation for each outcome resulting from issues of law terminating the litigation based on input-specified percentage odds of prevailing and dollar amounts expected to be gained or lost in the scope of attorney fees and costs relating to issues of law;
adjusting the valuation of each outcome for issues of law branches by adding input-specified expense of attorney fees and costs expended on establishing or defeating the legal viability of claims, taking into account whether attorney fees and costs are reciprocal, one-way shifting, or not subject to any shifting;
adjusting the valuation of each outcome for issues of law to account for input-specified prejudgment and/or postjudgment interest expended during the time required to establish or defeat the legal viability of claims;
adjusting the valuation of each outcome for issues of law to account for input-specified discount rate as applied to the remainder of the time period until final resolution;
computing the valuation for each outcome resulting from questions of fact resolving issues related to witness credibility, document authenticity, relative weights of evidence, and other issues going to evidentiary proof, including high, low, and other applicable estimates of money damages;
adjusting the valuation of each outcome for questions of fact to account for input-specified expense of attorney fees and costs expended to prove or disprove factual claims, taking into account whether attorney fees and costs are reciprocal, one-way shifting, or not subject to any shifting;
adjusting the valuation of each outcome relating to questions of fact to account for input-specified prejudgment and/or postjudgment interest on money damages corresponding to the time required to prove or disprove factual claims;
adjusting the valuation of each outcome relating to resolution of questions of fact to account for input-specified discount rate as applied to the remainder of the time period until final resolution;
computing the final expected value as the sum of expected, adjusted values of all possible outcomes;

2. The method of claim 1, wherein differences in intermediate and final computations due to revised, different, or additional data input from one or more users collaborating on valuation over a data or internet connection are computed;

3. The method of claim 1, wherein a non-transitory display of the decision tree, intermediate and final computations, and timeline are transmitted, printed, and/or otherwise rendered;

4. The method of claim 1, wherein odds, money damages, attorney fees, costs, and/or risk aversion premium are computed based on input-specified final expected value and other variables, with the risk aversion premium resulting from the difference between input specified final expected value and the computation resulting from the specified variables of damages, attorney fees, costs, interest, and discount rate.

5. The method of claim 1, wherein a computing device trains the user in the computer implemented method by presenting examples, eliciting input from the user, comparing user answers with result computed by the method of claim 1, and displaying the result.

6. The method of claim 1, applied to a database of multiple hypothetical, historical, or contemporaneous cases to determine statistics such as average, median, high, and low values for the cases in the data set.

7. The method of claim 1, applying to an action (such as a complaint and/or appeal) and applied to one or more cross-actions (such as cross-complaint(s) and/or cross-appeal(s)) and combining the value for the action and all cross-actions in two- and multi-party litigation.

8. A system, comprising:
a networked or non-networked environment of data storage and exchange between at least one user, at least one processor or distributed fractional processing resulting in the functional equivalent of a processor, and at least one display mechanism (whether transitory, non-transitory, and/or tangible) which are configured to:
generate a decision tree showing the flow of litigation to possible outcomes based on whether the valuation pertains to a case before judgment, after judgment, or for the entirety of a case before and after judgment, the type of case being identified by input from a user device or server;
compute the valuation for each outcome resulting from issues of law terminating the litigation based on input-specified percentage odds of prevailing and dollar amounts expected to be gained or lost in scope of attorney fees and costs relating to issues of law;
adjust the valuation of each outcome for issues of law branches by adding the expense of input-specified attorney fees and costs expended on establishing or defeating the legal viability of claims, taking into account whether attorney fees and costs are reciprocal, one-way shifting, or not subject to any shifting;
adjust the valuation of each outcome for issues of law to account for input-specified prejudgment and/or postjudgment interest expended during the time required to establish or defeat the legal viability of claims;
adjust the valuation of each outcome for issues of law to account for a discount rate as applied to the remainder of the time period until final resolution;
compute the valuation for each outcome resulting from questions of fact resolving issues related to witness credibility, document authenticity, relative weights of evidence, and other issues going to evidentiary proof, including high, low, and other applicable estimates of money damages;
adjust the valuation of each outcome for questions of fact to account for the expense of attorney fees and costs expended to prove or disprove factual claims, taking into account whether attorney fees and costs are reciprocal, one-way shifting, or not subject to any shifting;
adjust the valuation of each outcome relating to questions of fact to account for prejudgment and/or postjudgment interest on money damages corresponding to the time required to prove or disprove factual claims;
adjust the valuation of each outcome relating to resolution of questions of fact to account for the discount rate as applied to the remainder of the time period until final resolution;
compute the final expected value as the sum of expected, adjusted values of all possible outcomes.

9. The system of claim 8, wherein differences in intermediate and final computations due to revised, different, or additional data input from one or more users collaborating on valuation over a data or internet connection are computed.

10. The system of claim 8, wherein a non-transitory display of the decision tree, intermediate and final computations, and timeline, are transmitted, printed, and/or otherwise rendered.

11. The system of claim 8, wherein the system trains the user by displaying examples, eliciting input from the user, comparing user answers with result computed by the method of claim 6, and displaying the result of the comparison.

12. The system of claim 8, wherein at least one processor is configured to apply to a database for multiple hypothetical, historical, or contemporaneous cases to determine statistics such as average, median, high, and low, values for the cases in the data set.

13. The system of claim 8, wherein at least one processor is configured to apply to an action (such as a complaint and/or appeal) and applied to one or more cross-actions (such as cross-complaint(s) and/or cross-appeal(s)) and combining the value for the action and all cross-actions in two- and multi-party litigation.

14. A non-transitory computer readable medium encoded with a computer program comprising instructions that when executed cause a computer to perform operations:
generating a decision tree showing the flow of litigation to possible outcomes based on whether the valuation pertains to a case before judgment, after judgment, or for the entirety of a case before and after judgment;
computing the valuation for each outcome resulting from issues of law terminating the litigation based on percentage odds of prevailing and dollar amounts expected to be gained or lost in the following categories: scope of attorney fees and costs relating to issues of law;
adjusting the valuation of each outcome for issues of law branches by adding the expense of attorney fees and costs expended on establishing or defeating the legal viability of claims, taking into account whether attorney fees and costs are reciprocal, one-way shifting, or not subject to any shifting;
adjusting the valuation of each outcome for issues of law to account for prejudgment and/or postjudgment interest expended during the time required to establish or defeat the legal viability of claims;
adjusting the valuation of each outcome for issues of law to account for the discount rate as applied to the remainder of the time period until final resolution;
computing the valuation for each outcome resulting from questions of fact resolving issues related to witness credibility, document authenticity, relative weights of evidence, and other issues going to evidentiary proof, including high, low, and other applicable estimates of money damages;
adjusting the valuation of each outcome for questions of fact to account for the expense of attorney fees and costs expended to prove or disprove factual claims, taking into account whether attorney fees and costs are reciprocal, one-way shifting, or not subject to any shifting;
adjusting the valuation of each outcome relating to questions of fact to account for prejudgment and/or postjudgment interest on money damages corresponding to the time required to prove or disprove factual claims;
adjusting the valuation of each outcome relating to resolution of questions of fact to account for the discount rate as applied to the remainder of the time period until final resolution;
computing the final expected value as the sum of expected, adjusted values of all possible outcomes.

15. The computer readable medium of claim 14, further comprising the instructions that when executed cause the computer to perform operations wherein differences in intermediate and final computations due to revised, different, or additional data input from one or more users collaborating on valuation over a data or internet connection are computed.

16. The computer readable medium of claim 14, further comprising the instructions that when executed cause the computer to perform operations to transmit, render, or print a non-transitory display of the decision tree, intermediate and final computations, and timeline.

17. The computer readable medium of claim 14, further comprising the instructions that when executed cause the computer to perform operations wherein percentage odds, money damages, attorney fees, costs, and/or risk aversion premium are computed based on input-specified final expected value and other variables, with the risk aversion premium resulting from the difference between input specified final expected value and the computation resulting from the specified variables of damages, attorney fees, costs, interest, and discount rate.

18. The computer readable medium of claim 14, further comprising the instructions that when executed cause the computer to perform operations wherein the system trains the user by presenting examples, eliciting input from the user, comparing user answers with result computed by the method of claim 11, and displaying the result of the comparison.

19. The computer readable medium of claim 14, further comprising the instructions that when executed cause the computer to apply operations to a database for multiple hypothetical, historical, or contemporaneous cases to determine statistics such as average, median, high, and low, expected final values for the cases in the data set.

20. The computer readable medium of claim 14, further comprising the instructions that when executed cause the computer to perform operations wherein at least one processor is configured to apply to an action (such as a complaint and/or appeal) and applied to one or more cross-actions (such as cross-complaint(s) and/or cross-appeal(s)) and combining the value for the action and all cross-actions in two- and multi-party litigation.
